(19) United States
(12) Patent Application Publication
(10) Pub. No.: US 2015/0296123 A1
(43) Pub. Date: Oct. 15, 2015

(54) Advanced Fast Autofocusing

(71) Applicant: Broadcom Corporation, Irvine, CA (US)

(72) Inventors: Ilya Blayvas, Holon (IL); Eduard Oks, Bat Yam (IL); Tomer Schwartz, Even Yehuda (IL); Noam Sorek, Zichron Yacoov (IL); Ilia Vitsnudel, Even Yehoda (IL)

(21) Appl. No.: 14/319,391

(22) Filed: Jun. 30, 2014

Related U.S. Application Data
(60) Provisional application No. 61/979,353, filed on Apr. 14, 2014.

(51) Int. Cl. H04N 5/232; G03B 13/36

(52) U.S. Cl. CPC H04N 5/23212; G03B 13/36

(57) ABSTRACT

Several autofocus techniques are disclosed. The autofocus techniques help the device to achieve focus without presenting unpleasant blurred images to the operator of the camera, e.g., by dividing image frames into technical frames and display frames, with autofocus search occurring during technical frames. With another technique, the upper bound of the spatial frequencies of the blurred image permits a calculation of the focused lens position. Another technique searches for focus in jumps that exponentially decrease the search space with each jump. In another focusing technique, the lens is moved through a range of positions during a frame acquired with a rolling shutter exposure and the focused position may be determined from the sharpest row of the frame.

### CROSS REFERENCE TO RELATED APPLICATIONS

This application claims priority to provisional application Ser. No. 61/979,353, filed Apr. 14, 2014, which is incorporated by reference in its entirety.

### TECHNICAL FIELD

This disclosure relates to digital imaging. This disclosure also relates to focus techniques for digital imaging.

### BACKGROUND

Rapid advances in electronics and communication technologies, driven by immense customer demand, have resulted in the worldwide adoption of devices that include digital cameras. Examples of such devices include smartphones, tablet computers, and dedicated digital cameras. Improvements in focus techniques will help meet the demand for ever increasing image quality.

### BRIEF DESCRIPTION OF THE DRAWINGS

FIG. 1 shows an example of a device that may implement autofocus techniques.

FIG. 2 is an example of logic that a device may implement for autofocus.

FIG. 3 shows logic for a logarithmic search for focus.

FIG. 4 shows a plot of the composite focus measure comprised of several focus measures computed at different resolution scales.

FIG. 5 shows a plot of the lens spatial frequency cut-off as a function of lens displacement from the focused position.

FIG. 6 illustrates different cut-offs of the spatial spectrum for different lens defocuses.

FIG. 7 shows one embodiment of logic for an analytical focusing method.

### DETAILED DESCRIPTION

One goal for autofocus is to adjust an imaging system (e.g., adjust the focus of a lens) so that the image of an object of interest is sharp on the image sensor. The autofocus techniques described below facilitate achieving focus quickly, and robustly, while decreasing or eliminating unpleasant image artifacts caused by focus hinting, slow, inconsistent or incorrect focusing. For instance, the techniques described below help reduce or eliminate image artifacts caused by sweeping lens position, in a search for sharp focus, that cases lens overshoot on either side of the sharp focus position, with the sweep sometimes creating unpleasant to view oscillations in blur of a displayed image.

The methods described below may be applied to the different systems that adjust focus that are current known art or that are developed in the future. In particular, adjusting the system focus may include movement of the lens, of an optical mirror, or of the image sensor; a change in shape of the lens or the mirror; or varying the index of refraction of the lens; or other adjustments. The imaging system which implements the autofocus techniques may acquire individual images, a burst of multiple images, a stream of images combined or encoded to form video, or perform any other type of image acquisition. Several autofocus methods are disclosed below, and each may be used separately, or used in connection with any others.

The autofocus techniques may determine focus according to a focus measure or Figure Of Merit (FOM). For example, the FOM may be a sum of absolute differences between neighboring pixels, or the sum of absolute differences between neighboring patches of pixels, but other FOMs may also be used. A patch may be a 2×2, 4×4 or ‘n’×‘m’ pixels, where ‘n’ and ‘m’ are any integer number and the patches are shape can be square, rectangular or other shape.

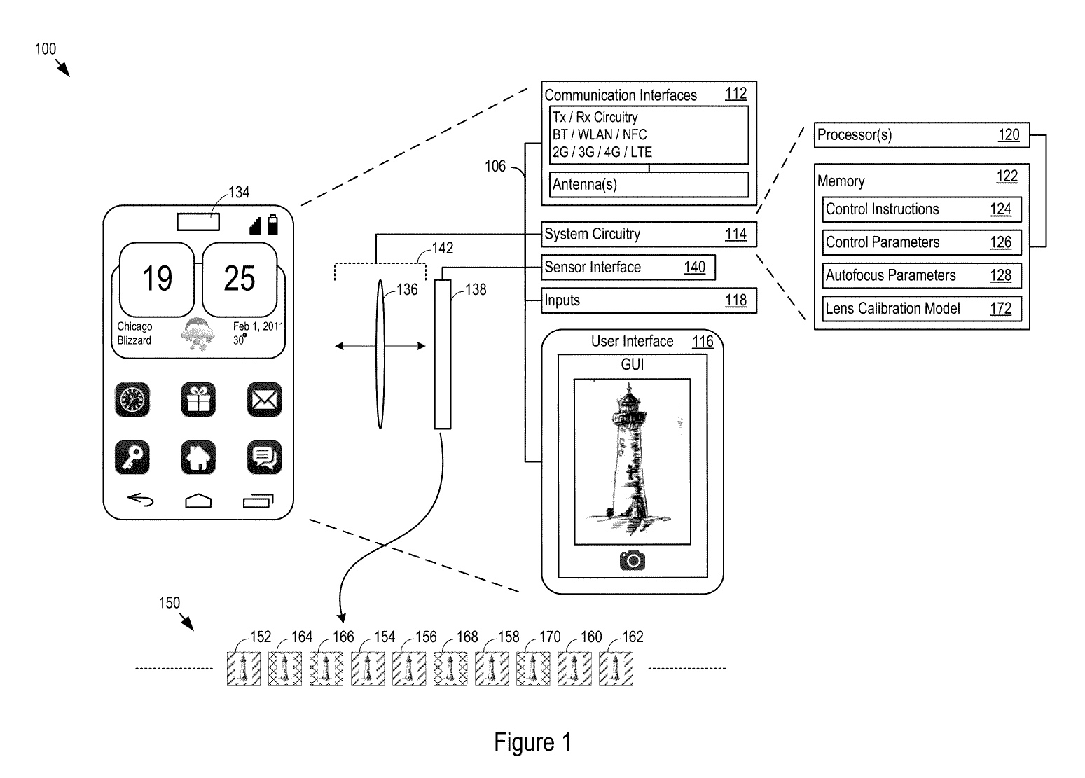

FIG. 1 shows an example of a device 100. The device 100 is a smartphone in this example, but the techniques described below regarding focusing may be implemented any type of digital imaging cameras, which can be a stand alone camera, or a part of some other device or system. Virtually any device or system may include a digital camera system that implements the autofocus techniques described below. Additional examples of devices include tablet computers, portable digital cameras, web cameras, personal computers, wearable devices, automobiles, and portable gaming systems. Accordingly, the smartphone example described below provides just one example context for explaining the focusing techniques, which are not limited to implementation in a smartphone.

The device 100 includes communication interfaces 112, system logic 114, and a user interface 116. The system circuitry 114 may include any combination of hardware, software, firmware, or other logic. The system circuitry 114 may be implemented, for example, with one or more systems on a chip (SoC), application specific integrated circuits (ASIC), discrete analog and digital circuits, and other circuitry. The system circuitry 114 is part of the implementation of any desired functionality in the device 100. In that regard, the system circuitry 114 may include logic that facilitates, as examples, capturing images or recording video, and performing autofocus operations. The user interface 116 may include a touch sensitive.

The system circuitry 114 may include circuitry that facilitates operation of the device 100 (e.g., one or more processors 120 and memories 122). The memory 122 stores, for example, control instructions 124 that the processor 120 executes to carry out desired functionality for the device 100. The control parameters 126 provide and specify configuration and operating options for the control instructions 124. The memory 120 may also store any images or video captured by the device 100, encoded in any available format, such as Join Photographic Experts Group (JPEG) or Motion Pictures Experts Group (MPEG). In that regard, the autofocus parameters 128 may provide parameter values that influence how autofocus operations as carried out by the control instructions 124, as described below.

In support of imaging applications, the device 100 may include a camera 134. For instance, FIG. 1 shows a front-facing camera, and other cameras (e.g. a rear-facing camera) may be provided instead, or in addition to the front-facing camera. The camera 134 may include a focusing lens 136, an image sensor 138, and a sensor interface 140. The focusing lens 136 may be under control of the system circuitry 114 to adjust focus on the image sensor 138 (e.g., as measured by sharpness of a region of interest in the image). To that end, the device 100 may include a focus changing apparatus 142 that physically moves the lens, mirror or sensor as directed by the system circuitry 114, or changes the focusing by other techniques now known or developed in the future. The image sensor 138 may be a solid state (e.g., Charge Coupled Device (CCD) or Complementary Metal Oxide Semiconductor (CMOS)) imager or other type of image sensor. The sensor interface may include row and column scanning circuitry and A/D (analog to digital) converters that read the image data (e.g., the pixel values) acquired by the image sensor 138 after an exposure. In other words, the system circuitry 114 reads image frames 150 from the image sensor 138 through the sensor interface 140.

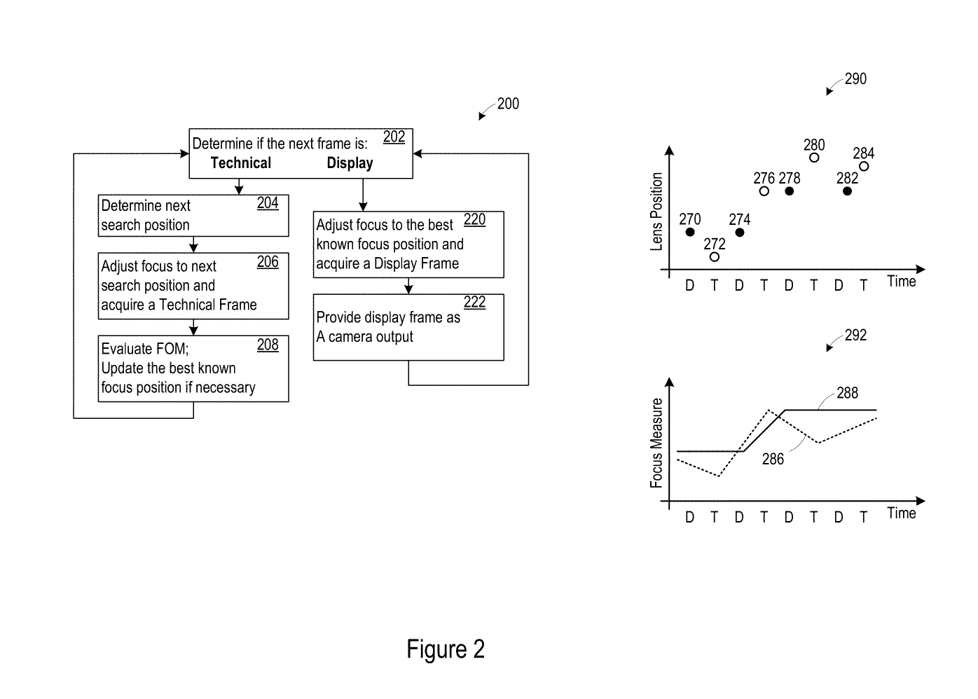

FIG. 2 shows logic 200 for autofocus that, the disclosed autofocusing cameras may implement. At (202) the logic 200 determines if the next acquired frame will be a ‘display frame’ provided for camera output (including displaying, transmitting storage, or further processing) (202) or a ‘technical frame’ used for searching for focus. The system circuitry 114 may perform the allocations of technical and display frames according to any pre-determined selection criteria, which may change dynamically or remain static during device operation.

In other words, the sequence of image frames 150 from the image sensor 138 is divided into display frames and technical frames. Any image frame may be used as either a display frame or a technical frame based on the allocation criteria.

As examples, the allocation criteria may allocate as a technical frame or a display frame: every ‘n’th frame (e.g., ever second, fifth, or tenth frame); ‘n’ out of ‘m’ frames (e.g., 2 frames out of 5 as technical frames or display frames, or even 0 technical frames out of ‘m’ image frames when autofocus is disabled); frames that occur at or over certain times, on a periodic basis, at random, or according to a schedule. FIG. 1 shows an example of display frames 152, 154, 156, 158, 160, 162 and technical frames 164, 166, 168, and 170 allocated from among the image frames obtained from the image sensor 138.

Because the logic 200 changes focus parameters during technical frames, the images captured in the technical frames may have varying focus, sometimes better, and sometimes worse. Those varying focus frames need not be output to the display, so that the operator of the device can avoid viewing image frames of possibly varying focus. That is, the display frames output may show only the same or improving focus, rather than oscillating blur, because focus adjustments are made during the technical frames which are not displayed. In that respect the autofocusing process is hidden from the operator. In that regard, the logic 200 moves the lens 136 to the best known focus position, acquires display frames (220), and outputs the display frames (222).

During technical frames, the logic determines the next focus search position, according to one of the algorithms disclosed in the present invention, or known in the prior art (204), moves the lens to the next focus search position and acquires a technical frame (206), and determines a FOM for focus using any of the techniques described in this document or any other selected FOMs for focus (208). If the evaluated FOM is better than the previous best known FOM, then the best known FOM and best focus position are updated (208).

FIG. 2 also shows how autofocus may execute with increasing focus delivered to the display for view by the operator. Plot 290 has a vertical axis of lens position and a horizontal axis of time, where ‘D’ denotes a display frame and ‘T’ denotes a technical frame. Solid points 270, 274, 278, and 282 denote lens position during the display frames, while contour points 272, 276, 280, 284 denote the position of the lens during technical frames. The lower plot 292 shows the focus measure 286 that was determined for each of the frames, and also the focus measure 288 delivered in the display frames.

In this example, focus is degrading at lens positions 272, 280, and therefore the lens position during display frames 274 and 282 remained unchanged from the prior best focus position, adopted during the previous display frames 270 and 278. That is, the lens position remained in the best focus position found up to that point, for the display frames. As one result, the display frame output (e.g., to a display viewed by the operator) did not experience any decrease in focus, although the focus was worse during the technical frames at points 272, 280, and 282. The lower plot 292 shows the oscillation in focus measure 286 during technical frames, and non-decreasing focus measure 288 during display frames.

The disclosed focusing methods may employ rolling shutter operation. With rolling shutter operation, the system exposes different parts of the image sensor at different periods in time (e.g., as opposed to exposing the entire image at once). For instance, the first row may be exposed and readout first in time, and the last row in the image sensor may be exposed and readout last in time, and the intermediate lines may be exposed at respective intermediate, possibly overlapping periods. According to one embodiment, with rolling shutter operation, the autofocus techniques may move the lens during exposure of a single frame, and each image row may therefore being acquired lens position (and resulting focus) different than other rows. The lens may move during the exposure. The individual rows may be analyzed to find the rows where the image is the sharpest (e.g., by determining the sum of absolute differences of a pixel value and neighboring pixels), and thereby determine the corresponding lens position for the sharp focus. The image sharpness may be determined as an average sharpness of pixels in that row, for example, by the sum of absolute differences with the neighbor pixels, or other focus FOM.

The partitioning into display and technical frames may be optional and may be flexible, where the display frames may still be used for focus search and evaluation of the focus measure, and the technical frames may still be used to provide camera output—for displaying, storage, transmission, processing or other uses and purposes.

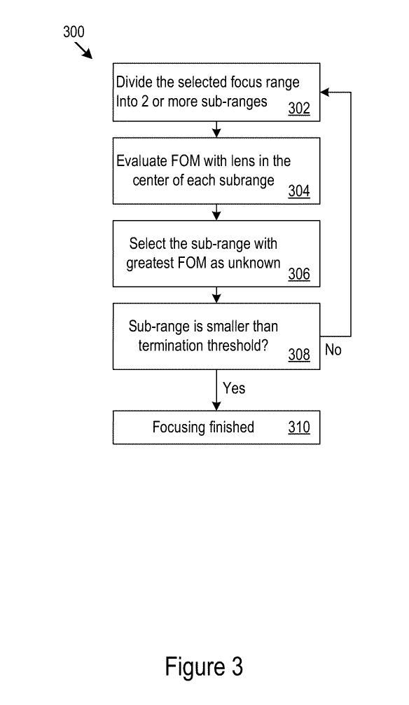

FIG. 3 illustrates an autofocus search technique referred to as a ‘logarithmic autofocus search technique’. The reference to ‘logarithmic’ is due to the fast convergence of the technique towards the sharp focus, where the number of evaluated focus positions is in typical cases proportional to the logarithm to the number of distinguishable focus positions of the range. Since two sufficiently close focus positions may be indistinguishable (produce equally sharp image of the object), for most optical systems there may be only up to few tens of distinguishable focus positions. For example, if there are up to 16 distinguishable positions, then 4 iterations of the algorithmic search (in the case of binary division of the range into two sub-ranges) will find the best focus; for 32 distinguishable focus positions 5 iterations find the best focus, for 64 positions, 6 iterations find the best focus, and so on. The logarithmic search may be a binary search that reduces focus region uncertainty size in geometric sequence. As a result, the uncertainty region size decreases exponentially with the number of steps, and the technique reduces the search space to a relative small number of steps (e.g., between 2 and 8) in a logarithmic relation to the size of the search space. The logarithmic search may take advantage of the ability to move the lens quickly over a large range during a single frame interval.

The logic 300 divides a search range into two or more sub-ranges (302) and evaluates a focus FOM with the lens positioned in the center of each sub-range (304). The sub-range with the greatest FOM is selected (306). If the FOM of both sub-regions was equal, either of the subregions may be selected, or the new subregion placed between them may be defined. Accordingly, the logic 300 selects the sub-range containing the sharpest focus position among the sub-ranges, as evaluated in the middle focus position of each sub-range. If the selected sub-range is smaller than a search termination threshold (308), the search terminates (310); otherwise the search continues recursively for the selected sub-range from (302).

Due to the exponentially decreasing size of the search space, four to eight iterations may be sufficient for most practical cases. After four iterations uncertainty is reduced to 1/16^{th} of the initial search range, and after eight iterations uncertainty is reduced to 1/256^{th} of the initial search range.

For some focus measures and large steps between focus positions, the focus measure maximum may not be found between steps. The largest step that ensures that the maximum focus is found will be referred to as the maximum robust focus step. The maximum robust focus step will normally depend on the chosen focus measure, and may be a function of the current focus position, and lens aperture and it may be calculated based on worst case scene conditions, to be independent of any given scene. Note that the focus range may be divided into more than two subranges (e.g., 3 or 4 subranges), and the logic may evaluate a corresponding focus measure in the middle of each subrange. To use a large focus step, a robust large-range focus measure may be used. However, such measures often have gradual and wide maximums making challenging or impossible to find exact focus position. Therefore a focus measure is disclosed below for finding focus in a robust manner with high sensitivity near the focus peak.

Discussed next is a robust focus measure that has a large range of robustness and a high sensitivity near the focus peak. One of the ways to calculate a focus measure is the Sum of Absolute Differences (SAD) between the neighbor pixels, or between the neighbor patches of pixels, where the patch may be a square of 2×2, 4×4, or n*n pixels, where n is any integer number. The SAD of neighbor patches may be calculated in two steps: first, the patch value, which is an image average within that patch is calculated; second the SAD between patch values is calculated. The patch may also have a non-square form. The FOM is composed to provide a sharp maximum at the sharp focus position, and to provide a strict monotonic increase as the lens approaches the sharp focus position.

The robust focus measure may be implemented as the sum of focus measures calculated with different patch sizes. In one embodiment the focus measure is the sum of (1) the SAD of neighbor pixels and (2) the SAD of neighbor 8×8 patches and the (3) the SAD of neighbor 64×64 patches. The first component (1) provides a sharp maximum at the exact focus position, and is sensitive to the defocusing of single pixel, the third component (3) provides a robust strict monotonic increase of the focus measure even far from the sharp focus position, where the image is blurred on the scale of 64×64 pixels, or similar scales; the second term (2) provides sensitivity and robustness at the intermediate scales. Other calculations instead of SAD or, other patch sizes and shapes (including non-square shapes) and different numbers of scales may be chosen for any given implementation of the disclosed focus measure.

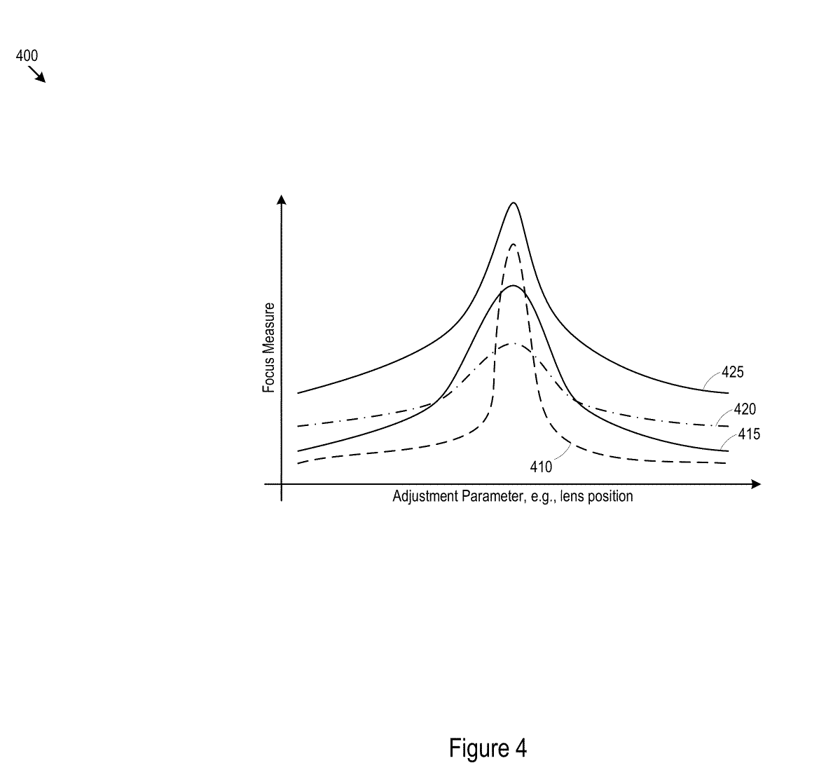

FIG. 4 illustrates the composition of a robust focus measure 400. The FOM 410 shows the FOM determined as the SAD of neighbor pixels. The FOM 410 has a sharp maximum around the sharp focus position, which provides an accurate determination of the sharp focus position. However the FOM 410 is almost flat when the focus is far away from the sharp focus position, and it is therefore less robust for positions far from focus, especially for a noisy image or scene. The FOM 420 shows the FOM constructed as SAD of bigger neighbor patches (e.g., not just neighbor pixels), such as 64×64 patches. The FOM 420 is robust even at large distances from focus, but has a relatively flat peak at the maximum, and therefore does not provide an accurate and exact sharp focus position. The FOM 415 shows a FOM at the intermediate scale, combining advantages and disadvantages of the FOM's 410 and 420.

The robust FOM 425 is constructed as a weighted sum of multiple FOMs, e.g., the FOMs 410, 415 and 420. The robust FOM 425 has both a sharp maximum and a significant gradient even at far distances from the sharp focus. The weighting may be equal for each component FOM, or adjusted empirically to provide good locking on exact focus position and robustness far from focused position.

The image magnitude of image blur is related to the distance from sharp focus position. This relation can be calculated analytically in the simulation of the optical system or measured in the calibration. Therefore, by calibrating the optical system and measuring the blur in the defocused image, one can calculate the distance to the sharp focus position. The remaining ambiguity may be the direction towards the sharp focus: the direction towards the focused position may be towards or infinity.

The analytical autofocusing method assumes that there are fine features or sharp edges in the image. Then, from the blur and point spread function of the sharp edge, the device 100 may evaluate the value of defocus for a pre-calibrated lens. The device 100 may then jump in a single step (e.g., by moving the lens 136 to a specific position) to the sharp focus position, or in two steps, if the first selection between two possible focused position was wrong. If there are fine features or sharp edges within the region of interest, then its spatial Fourier transform of will have energy in all or almost all spatial frequencies. These frequencies include the highest frequencies, defined by the joint resolution of the optics and image sensor. In the defocused image, however, the fine details will be blurred and therefore the high frequency components will be absent in the spatial Fourier transform. Calibrating the lens at different distances from the focused position allows determination of the relation between the cut-off frequency of the Fourier transform with the distance to the focused lens position. This calibration may be analytically calculated (e.g., once for each lens model), and stored in the memory for use during analytical autofocusing.

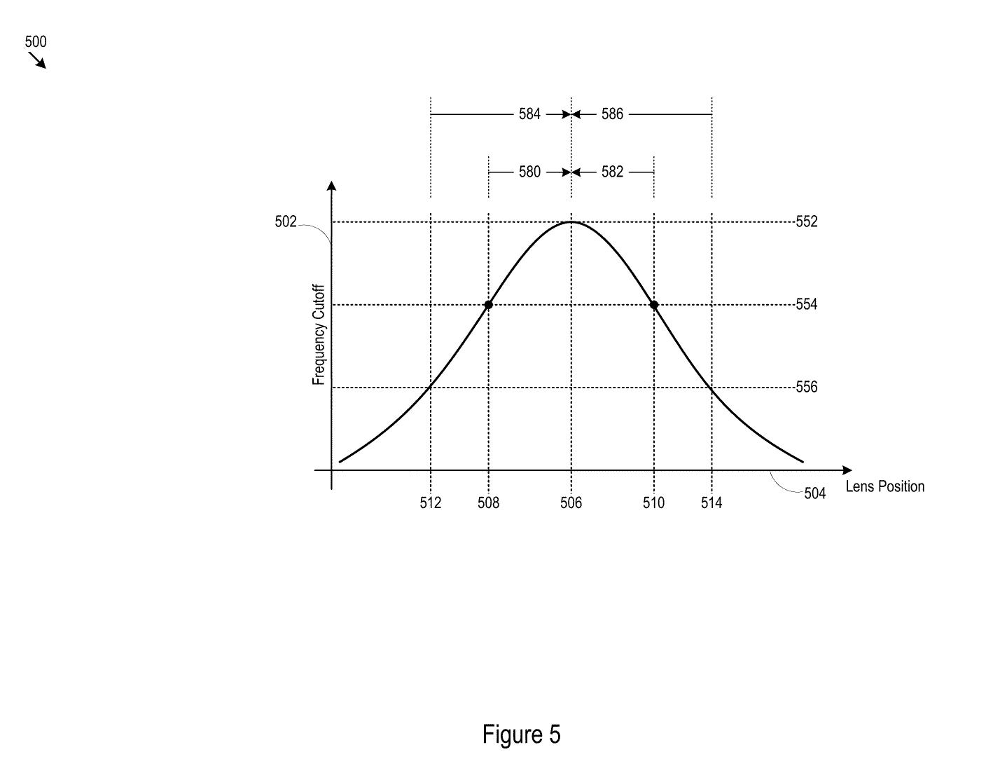

FIG. 5 illustrates example results 500 of the lens calibration. The plot shows the inverse spatial lens resolution, which is a spatial frequency cut-off of the lens, as a function of defocus from the sharp focus position. Several such curves at different lens positions and aperture values may be taken, and their values in the intermediate positions and apertures may be determined by interpolation. Position 506 corresponds to the sharp position of the lens when the scene is focused, and frequency cutoff value 552 to the maximum lens resolution, and therefore maximum frequency cut-off. If the lens is moved to the positions 510 or 508, the scene is slightly blurred, and the lens spatial frequency cut-off decreases to the frequency cutoff value 554. If the lens is further moved towards points 514 or 512, the frequency cut-off values further fall to value 556.

Therefore, if the acquired image has a frequency cut-off value equal to that denoted by 554, the lens shift towards the sharp focus will be either the step 582 or 580. Similarly, if the frequency cut-off corresponds to value denoted by 556, the lens shift towards the sharp focus will be the step 586 or 584.

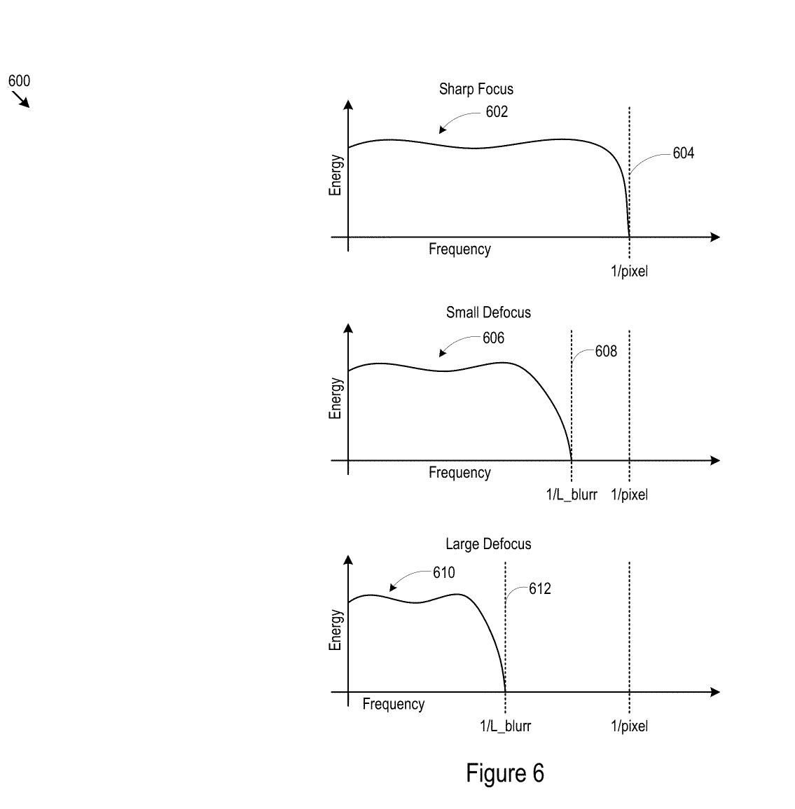

FIG. 6 is another illustration 600 of the principles described above with respect to FIG. 5. The curve 602 shows the image spatial spectrum for a sharp image and its corresponding frequency cutoff 604 of nearly 1/pixel. The curve 606 shows the spatial spectrum of slightly blurred image, and it has a frequency cut-off of 608. The curve 610 shows a more blurred image, with a lower frequency cut-off 612. Therefore, an analysis of an acquired image may provide a determination of the frequency cut-off. From the frequency cutoff and the lens calibration curve (FIG. 5), the system may determine a step that immediately reaches a sharp focus position.

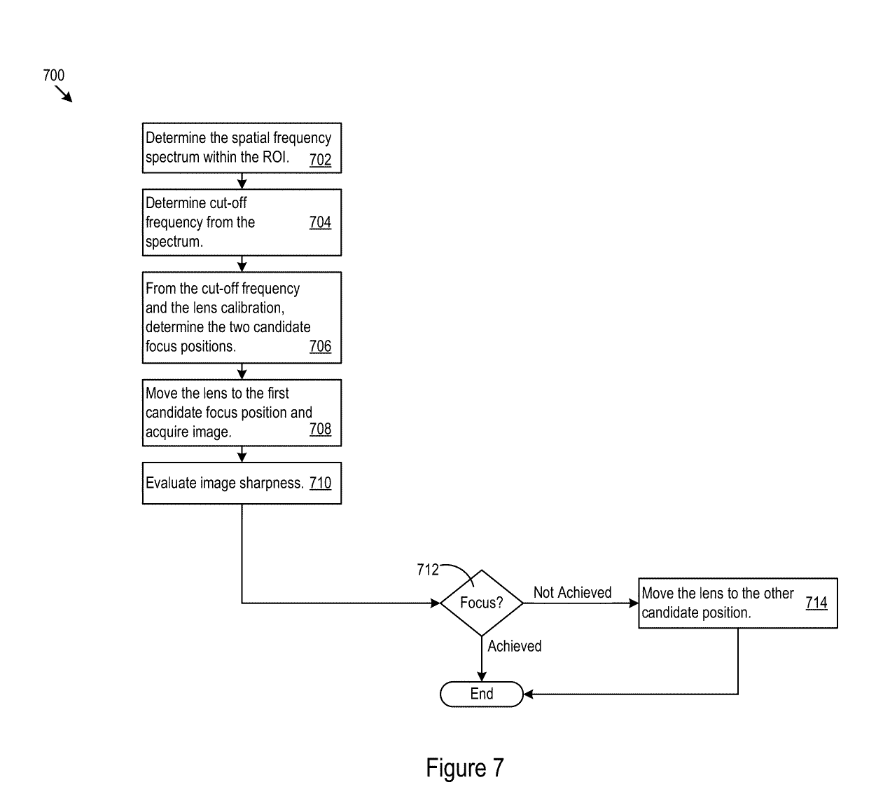

FIG. 7 shows logic 700 for analytical focus that the system circuitry 114 may implement. First, a lens calibration is done to determine the upper frequency bound of the lens blur as a function of defocusing value. The calibration may be done by measurement or simulation, as examples. The calibration may be done, for instance, one time for every type of lens, and stored in the memory for further use. Second, the region of interest (ROI) is selected. It may be set by the user, or selected by an algorithm to be some object of interest, such as a face. Then, a spatial Fourier transform of the selected region is performed at (702), and the upper frequency bound (also referred as frequency cut-off) of the frequency spectrum of the ROI is calculated at (704);

From the upper frequency bound and the lens calibration the distance to the lens sharp focus position is calculated at (706). In the general case there will be two such distances, one in the infinity direction, and one in the near direction. In general cases the distances in these two different directions may differ, as can be measured in calibration or calculated in simulation. In some cases, when the lens is close to one of the end positions, and the blur exceeds the maximum blur possible in the direction of the closer end, only one lens direction will be possible. If there is only one possible lens direction, the autofocus technique may move the lens to that position in one step, and the focusing is finished using a single analytical step.

If two directions for movement of the lens are possible, the autofocus technique may employ heuristics to choose or guess a direction to select between the two possible positions. After the lens is moved to the first position (708), the image is acquired, and the ROI is analyzed again (710). If the image is sharp, then the adjustment was correct. If the image is blurred (it will be even more blurred, since the lens was moved in the wrong direction), than the lens is moved to the second position (714), which was the correct one, and the focusing process is finished. Thus, with the analytical focusing technique, the focusing in most cases is reached in a single step, and in two steps in the worst case. For practical systems, working at 60 fps or 30 fps speeds, this will mean focusing in 17 milliseconds or 33 milliseconds, compared to the hundreds of milliseconds and multiple frames often required by prior systems.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

Various implementations have been specifically described. However, many other implementations are also possible.

What is claimed is:

1. A method of automatic focusing, comprising:
acquiring image frames from an image sensor;
distinguishing the image frames between technical frames for autofocus search and display frames to represent camera output; and
for autofocus search:
for a selected technical frame, specifying a new focus position for a lens associated with the image sensor; and
evaluating a focus measure for the selected technical frame at the new focus position.

2. The method of claim 1, further comprising:
for a selected display frame, specifying a focus position for the lens at the sharpest known focus position.

3. The method of claim 2, further comprising:
providing subsequent display frames at the sharpest known focus position as camera output.

4. The method of claim 1, where the technical frames are interleaved with the display frames.

5. The method of claim 2, further comprising:
updating the sharpest known focus position when the focus measure indicates better focus.

6. A method of claim 1, where:
at least one the technical frames was exposed with a rolling shutter technique by which different rows of a corresponding image frame were exposed at different times; and further comprising:
changing the lens focusing during exposure of the corresponding image frame to capture varying focus caused by different focus positions at different image rows;
analyzing the varying focus captured in the image frame to find sharp focus and a corresponding lens position for the sharp focus.

7. A method of claim 1, where evaluating the focus measure comprises:
determining a first contribution to a composite focus measure as a sum of absolute differences of neighbor pixels within an image region;
partitioning the image region into image patches and determining an average image value for each of the image patches;
determining a second contribution to the composite focus measure as a sum of absolute differences of the average image values; and
determining the composite focus measure as a sum of the first contribution and the second contribution.

8. A method comprising:
determining a focus search range for image focus;
a) dividing the search range into a first sub-region and a second sub-region;
b) specifying a first lens position within the first sub-region;
c) acquiring a first image at the first lens position;
d) specifying a second lens position within the second sub-region;
e) acquiring a second image at the second lens position;
f) determining a first focus measure on the first image;
g) determining a second focus measure on the second image;
g) selecting between the first and second sub-region based on which of the first and second focus measure is greatest; and
repeating a)-g) for the selected sub-region for a predefined number of iterations.

9. The method of claim 8, where:
the first lens position and the second lens position are approximately at the middle of the first sub-region and the second sub-region, respectively.

10. The method of claim 8, where:
the focus search range corresponds to an entire available range over which a camera lens focus position may be adjusted.

11. The method of claim 8, where:
the search range corresponds to a subset of an available range over which a camera focus position may be adjusted.

12. The method of claim 8, where:
acquiring the first image occurs during a technical frame that is not provided as camera output.

13. The method of claim 8, where:
acquiring the second image occurs during a technical frame that is not provided as camera output.

14. A method of automatic focusing, comprising:
acquiring an image and selecting a region of interest (ROI) within the image;
performing a spatial frequency analysis of the ROI and evaluating an upper frequency bound;
comparing the upper frequency bound to a lens calibration model to determine a first single step focus adjustment and a second single step focus adjustment to a sharp focus position; and
moving a lens according to the first single step focus adjustment to the first sharp focus position.

15. The method of claim 15, further comprising determining whether sharp focus was achieved by the first single step focus adjustment; and
moving the lens according to the second single step focus adjustment to the sharp focus position, when sharp focus was not achieved by the first single step focus adjustment.

16. The method of claim 14, where the lens calibration model specifies the sharp focus position as a function of upper frequency bound.

17. The method of claim 16, where the lens calibration model specifies the sharp focus position as a function of frequency bound and lens aperture or focus position.

18. The method of claim 14, further comprising:
evaluating a decision factor to select the first single step focus adjustment for moving the lens instead of the second single step focus adjustment.

19. The method of claim 18, where the decision factor comprises:
current position of the lens.

20. The method of claim 19, where the decision factor is that current position of the lens allows for movement according to the first single step focus adjustment, but does not allow for movement according to the second single step focus adjustment.
